(19) United States
(12) Patent Application Publication
(10) Pub. No.: US 2008/0133296 A1
(43) Pub. Date: Jun. 5, 2008

(54) METHOD AND SYSTEM FOR MANAGING RELIABILITY OF IDENTIFICATION MANAGEMENT APPARATUS FOR USER CENTRIC IDENTITY MANAGEMENT

(75) Inventors: Dae Seon Choi, Daejeon (KR); Seung-Hyun Kim, Daegu (KR); Yeong Sub Cho, Daejeon (KR); Sang Rae Cho, Daejeon (KR); Jong Hyouk Noh, Daejeon (KR); Seung Hun Jin, Daejeon (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/931,988

(22) Filed: Oct. 31, 2007

(30) Foreign Application Priority Data
Dec. 5, 2006 (KR) 10-2006-0122573
Jul. 25, 2007 (KR) 10-2007-0074630

(51) Int. Cl. G06Q 10/00; G06F 17/40

(52) U.S. Cl. 705/7; 705/1

(57) ABSTRACT

Provided are a method and system for managing reliability of an identification (ID) management apparatus for user centric ID management.

Provided are a method and system for managing reliability of an ID management apparatus, whereby an application service providing apparatus can determine whether to trust a corresponding ID management apparatus without having a pre-agreement with an ID management apparatus regardless of which ID management apparatus is selected by a user in user centric ID management circumstances.

Therefore, reliability is determined according to types of information provided by the ID management apparatus, and reliability of the ID management apparatus can be determined according to a result of evaluation made by the application service providing apparatus instead of a particular single subject.

### CROSS-REFERENCE TO RELATED PATENT APPLICATION

This application claims the benefit of Korean Patent Application Nos. 10-2006-0122573 filed on Dec. 5, 2006 and 10-2007-0074630 filed on Jul. 25, 2007, in the Korean Intellectual Property Office, the disclosure of which is incorporated herein in its entirety by reference.

### BACKGROUND OF THE INVENTION

1. Field of the Invention

The present invention relates to a method and system for managing reliability of an identification (ID) management apparatus, and more particularly, to a method and system for managing reliability of an ID management apparatus whereby an application service providing apparatus can determine whether to trust a corresponding ID management apparatus without having a pre-agreement with an ID management apparatus regardless of which ID management apparatus is selected by a user in user centric ID management circumstances.

The present invention was supported by the Information Technology (IT) Research & Development (R&D) program of the Ministry of Information and Communication (MIC) [Project management number: 2005-S-060-02, Project title: Development of Universal Security Service Platform Technology for Protecting e-Identity].

2. Description of the Related Art

Identification (ID) management apparatuses for efficiently managing a user's ID have been developed and are now widely used. The ID management apparatus stores and manages user's personal information such as an ID, an address, or a phone number, and provides a single sign-on function by providing the personal information to a service providing apparatus or transmitting a result of user verification to the service providing apparatus.

A conventional ID management technology was conducted in a reliability region which is composed of one ID management apparatus and a plurality of application service providing apparatuses that trust the ID management apparatus. A user centric ID management technology, which is currently developed, employs a plurality of ID management apparatuses where ID information that is issued from an ID management apparatus from among the plurality of ID management apparatuses is selected by the user and transmitted to an application service providing apparatus. In the conventional ID management technology, since a reliability region is established by a pre-agreement between the application service providing apparatus and the ID management apparatus, the user has to use a predetermined ID management apparatus in order to use the predetermined application service providing apparatus.

On the other hand, in the current user centric ID management apparatus, the ID management apparatus may be selected according to the user's choice. However, in the current technology of the user centric ID management, a method of establishing a reliable relationship between the application service providing apparatus and the ID management apparatus is not provided. In other words, a method of establishing a reliable relationship between the application service providing apparatus and personal information or an authentication result provided by the ID management apparatus selected by the user.

In conventional ID management technology where a reliability relationship between the ID management apparatus and the application service providing apparatus is established by a pre-agreement, since the user has a limitation in selecting only ID management apparatuses which are trusted by a particular application service providing apparatus, it is difficult to provide the user with a freedom of choice which has been claimed by user centric ID management technology.

Meanwhile, the current reliability management is limited to the application service providing apparatus determining whether to trust information provided by the ID management apparatus, and there is no method of evaluating different reliabilities according to the type of provided information.

### SUMMARY OF THE INVENTION

The present invention provides a method and system of determining whether to trust information provided by an identification (ID) management apparatus without having a predetermined agreement between an application service providing apparatus and the ID management apparatus in user centric ID managing circumstances where the ID management apparatus is selected according to a user's choice.

The present invention also provides a method and system of individually evaluating a reliability of an ID management apparatus by an application service providing apparatus according to a type of information provided by the ID management apparatus.

Other purposes and advantages of the present invention will be evident from the description below and will become clear by the embodiments of the present invention. Also, these purposes and advantages can be realized according to a method or a combination of methods in the claim.

According to an aspect of the present invention, there is provided an application providing apparatus for managing reliability of an identification (ID) management apparatus, the apparatus including: an information using unit receiving ID information of a user from one of a plurality of ID management apparatuses that is selected by the user; a voting unit verifying the ID information after providing a service to the user based on the ID information, voting whether to trust the ID information based on a result of the verification, and transmitting a result of the voting to a reliability management apparatus that computes the result of the voting; and an evaluation unit receiving a reliability value calculated based on the result of the voting of the selected ID management apparatus from the reliability management apparatus, and determining whether to trust the selected ID management apparatus, if there is an inquiry whether to trust the selected ID management apparatus from the information using unit.

According to another aspect of the present invention, there is provided a reliability management system including: a plurality of ID management apparatuses selected according to a user's choice, and providing ID information of the user; a plurality of application service providing apparatuses providing a service to the user based on the received ID information, verifying the ID information, and voting whether to trust the ID management apparatus based on a result of the verification; and a reliability management apparatus computing a result of the voting made in the plurality of application service providing apparatuses, and calculating reliability value of the ID management apparatus.

According to another aspect of the present invention, there is provided a method of managing reliability of an ID management apparatus by an application service providing apparatus, the method including: receiving ID information of a user from one of a plurality of the ID management apparatuses that is selected by the user; providing a service to the user based on the ID information, and verifying the ID information; voting whether to trust the ID information based on a result of the verification; transmitting a result of the voting to a reliability management apparatus that computes the result of the voting; and receiving a reliability value calculated based on the result of the voting of the selected ID management apparatus from the reliability management apparatus, and determining whether to trust the selected ID management apparatus, if there is an inquiry whether to trust the selected ID management apparatus.

According to another aspect of the present invention, there is provided a method of managing reliability of an ID management apparatus, the method including: providing ID information of a user by using one of a plurality of the ID management apparatuses according to the user's choice; providing a service to the user by using an application service providing apparatus based on the received ID information, and verifying the ID information; voting whether to trust the ID management apparatus which provides the ID information by using the application service providing apparatus based on a result of the verification; and granting reliability value of the ID management apparatus by computing a result of the voting made in the plurality of application service providing apparatuses by using an reliability management apparatus.

According to another aspect of the present invention, there is provided a computer-readable medium having embodied thereon a computer program for executing the method of managing reliability of the ID management apparatus of the present invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram briefly explaining a structure of a reliability management system which determines whether to trust an identification (ID) management apparatus according to an embodiment of the present invention;

FIG. 2 is a flowchart briefly illustrating a method of managing reliability of an ID management apparatus according to an embodiment of the present invention;

FIG. 3 is a flowchart illustrating operations of an ID management apparatus for managing reliability of the ID management apparatus according to an embodiment of the present invention;

FIG. 4 is a flowchart illustrating operations of an application service providing apparatus for managing reliability of an ID management apparatus according to an embodiment of the present invention; and

FIG. 5 is a flowchart illustrating operations of a reliability management apparatus for managing reliability of an ID management apparatus according to an embodiment of the present invention.

### DETAILED DESCRIPTION OF THE INVENTION

The present invention will now be described more fully with reference to the accompanying drawings, in which exemplary embodiments of the invention are shown.

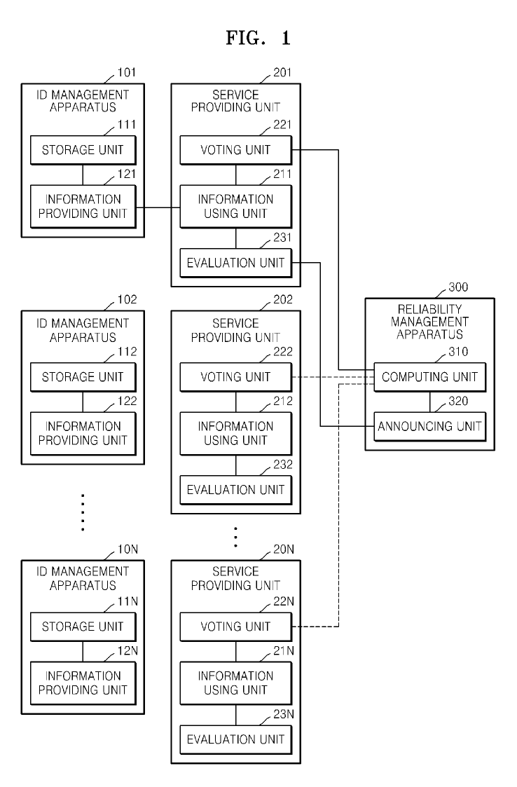

FIG. 1 is a block diagram briefly explaining a structure of a reliability management system which determines whether to trust an identification (ID) management apparatus according to an embodiment of the present invention.

Referring to FIG. 1, the reliability management system which determines whether to trust the ID management apparatus includes ID management apparatuses 101 through 10N, application service providing apparatuses 201 through 20M, and a reliability management apparatus 300. Hereinafter, one of each of the ID management apparatuses and service providing apparatuses will be explained, since it will be understood by those of ordinary skill in the art that an embodiment of each one can be applied to a plurality of ID management apparatuses and service providing apparatuses.

The ID management apparatus 101 is selected according to a user's choice and provides ID information of the user, and the ID management apparatus 101 includes a storage unit 111 and an information providing unit 121. There can be more than one ID management apparatus, and one of ID management apparatuses can be determined by the user.

The storage unit 111 stores various types of ID information of the user. The types of ID information can be a confirmation of verification, personal information, and personal location information. The ID information is used by the service providing apparatus to provide a service to the user who requested a service, and then it is verified for use for reliability evaluation on the ID management apparatus 101.

The information providing unit 121 receives a request for providing the user's ID information from the service providing apparatus 201, and provides the user's ID information in response to the request.

An application service providing apparatus (hereinafter, service providing apparatus) 201 requests ID information of the user to the ID management apparatus 101, provides an application service to the user by using the provided ID information, and votes and determines whether to trust the ID management apparatus 101. The service providing apparatus 201 includes an information using unit 211, a voting unit 221, and an evaluation unit 231. There may be a plurality of service providing apparatuses 201.

The information using unit 211 requests ID information of the user to the ID management apparatus 101 which is one of the plurality ID management apparatuses to receive the ID information, and provides a service to the user by using the corresponding information. Also, the information using unit 211 makes inquiries to the evaluation unit 231 whether to trust types of information provided by the ID management apparatus. The information using unit 211 receives the ID information from one of the plurality of ID management apparatuses according to the user's choice.

The service providing apparatus 201 provides a service to the user who wants to use the service, based on the ID information received in the information using unit 211, and then the voting unit 221 votes whether the ID information can be trusted. The voting unit 221 performs a post evaluation on the ID management apparatus 101 by verifying the ID information after an application service is provided based on the ID information of the user, and transmits the voting result on the reliability which is performed based on the result of the evaluation to a reliability management apparatus 300.

If a request has been made on the reliability of the ID management apparatus 101 that is selected by the user from the information using unit 211, the evaluation unit 231 is connected to the reliability management apparatus 300 and receives information on the reliability of the corresponding ID management apparatus, and determines whether to trust the corresponding ID management apparatus. The determination whether to trust the corresponding ID management apparatus is made according to types of information that is provided by the ID management apparatus 101. The evaluation unit 231 determines that the corresponding ID management apparatus 101 is reliable if a reliability value provided by the reliability management apparatus 300 is greater than a predetermined value, or determines that the corresponding ID management apparatus 101 is not reliable if the reliability value provided by the reliability management apparatus 300 is smaller than a predetermined value.

In order to evaluate the reliability of the ID management apparatus 101 according to types of the provided information, the reliability of the ID management apparatus 101 should be managed according to the types of information provided for each ID management apparatus. It is not appropriate to determine and grant a value of reliability of all types of information of all ID management apparatuses by a particular subject. Thus, the present invention provides a method of granting a value of reliability according to the evaluation of the service providing apparatus which uses information of the ID management apparatus 101, in other words, according to the result of evaluation of the ID management apparatus 101.

The reliability management apparatus 300 grants the reliability value of the ID management apparatus based on the result of voting on the reliability of each ID management apparatus performed by a plurality of service providing apparatuses. The reliability management apparatus 300 includes a computing unit 310 and an announcing unit 320.

The computing unit 310 computes a result of voting whether to trust each ID management apparatus provided by the plurality of service providing apparatuses 201 according to each type of information and stores the result. The computing unit 310 grants a reliability value of each ID management apparatus 101 by raising a value of the reliability if the result of voting is positive, and lowering a value of the reliability if the result of voting is negative.

The announcing unit 320 provides a reliability value on the corresponding ID management apparatus, when it receives a request for reliability of a particular ID management apparatus and/or particular information.

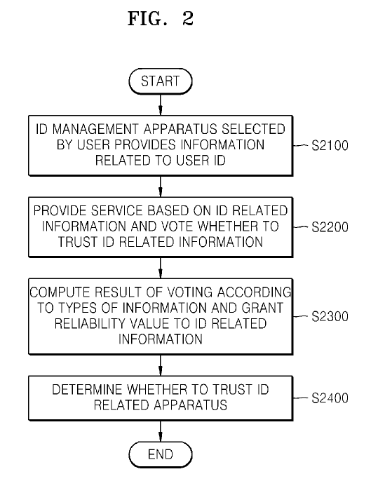

FIG. 2 is a flowchart briefly illustrating a method of managing reliability of an ID management apparatus according to an embodiment of the present invention.

Referring to FIG. 2, a method of a service providing apparatus determining whether to trust an ID management apparatus by using information on reliability obtained from a reliability management apparatus without having a predetermined agreement with the ID management apparatus, the method including the service providing apparatus voting whether to trust the ID management apparatus after using the ID information provided by the ID management apparatus, the reliability management apparatus computing a result of the voting according to types of information and obtaining the information on reliability, and the service providing apparatus determining whether to trust the ID management apparatus from the information on reliability provided by the reliability management apparatus.

First, the service providing apparatus is connected to the ID management apparatus selected by the user from among a plurality of ID management apparatuses, and ID information of the user is provided (S2100). The ID information includes a verification confirmation, personal information, personal credit information, and personal location information.

The service providing apparatus provides a service to the user based on the provided ID information, and votes whether to trust the ID management apparatus by performing a post evaluation on the ID information (S2200). The service providing apparatus determines by itself whether the information can be trusted by summing up various standards such as an accuracy of the ID information, and a frequency of use.

The reliability management apparatus computes a result of the voting on the reliability of each ID management apparatus received from a plurality of service providing apparatuses, and grants the reliability value to each ID management apparatus (S2300). The result of the voting is computed and stored according to each type of ID management apparatus and each type of information. The reliability management apparatus grants a reliability value of each ID management apparatus by raising a value of the reliability if the result of the voting is positive, and lowering a value of the reliability if the result of the voting is negative. Thus, the reliability value of the ID management apparatus can be granted according to a result of the evaluation of the service providing apparatus.

When determining whether to trust the ID management apparatus, the service providing apparatus receives the information on reliability of particular ID information of a particular ID management apparatus from the reliability management apparatus, and determines whether to trust the ID management apparatus by comparing the reliability value with a predetermined standard value (S2400). Thus, the reliability of the ID management apparatus can be determined according to types of information.

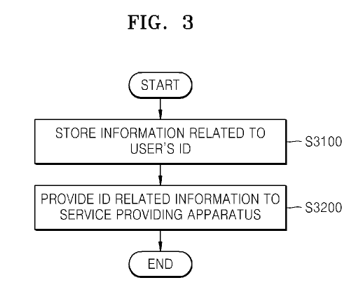

FIG. 3 is a flowchart illustrating operations of an ID management apparatus for managing reliability of the ID management apparatus according to an embodiment of the present invention.

Referring to FIG. 3, the ID management apparatus stores ID information according to each user (S3100). The ID information includes a verification confirmation, personal information, personal credit information, and personal location information.

When ID information of a particular user is requested from the service providing apparatus, the ID management apparatus provides the ID information of the user to the service providing apparatus (S3200). The provided ID information is used by the service providing apparatus when providing a service to the user, and a post evaluation is performed on the information. Then, it is determined whether to trust the corresponding ID management apparatus according to the result of the verification of the ID information.

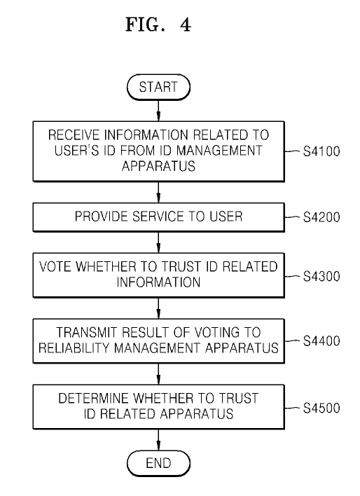

FIG. 4 is a flowchart illustrating operations of a service providing apparatus for managing reliability of an ID management apparatus according to an embodiment of the present invention.

Referring to FIG. 4, the service providing apparatus receives ID information of the user from the ID management apparatus (S4100). The ID management apparatus may be the apparatus selected by the user from among a plurality of ID management apparatuses.

The service providing apparatus provides the user based on the ID information, and performs a post evaluation (S4200).

The service providing apparatus then votes whether to trust the ID management apparatus according to the result of verification (S4300).

The service providing apparatus transmits the result of voting to the reliability management apparatus which computes the result of voting according to each ID management apparatus and each type of information, and grants the reliability on the ID information based on the result of voting (S440).

When determining the reliability of the ID management apparatus selected by the user, the service providing apparatus determines whether to trust the ID management apparatus by obtaining information on the reliability of the ID management apparatus from the reliability management apparatus (S4500). The information on the reliability can be determined according to types of information provided by the ID management apparatus. The service providing apparatus may determine whether to trust the ID management apparatus by finding out whether the reliability value provided by the ID management apparatus exceeds a predetermined value.

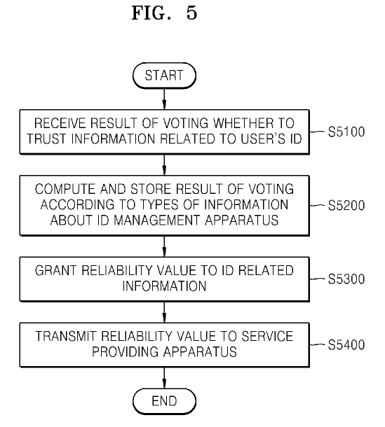

FIG. 5 is a flowchart illustrating operations of a reliability management apparatus for managing reliability of an ID management apparatus according to an embodiment of the present invention.

Referring to FIG. 5, the reliability management apparatus receives the result of voting on whether to trust the ID management apparatus which provides the ID information of the user from a plurality of service providing apparatuses (S5100).

The result of voting on whether to trust the ID management apparatus is computed according to a predetermined standard, such as each ID management apparatus or each type of information, and stored (S5200).

The reliability management apparatus grants a reliability value of the ID management apparatus by raising a value of the reliability if the result of voting is positive, and lowering a value of the reliability if the result of voting is negative (S5300).

When the service providing apparatus requests information on the reliability of a particular ID management apparatus, the reliability value granted to the corresponding ID management apparatus is provided according to types of information (S5400). The service providing apparatus may determine whether to trust the corresponding ID management based on the reliability value provided by the reliability management apparatus.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

The present invention ensures a freedom of choice for a user and achieves real user centric ID management since an application service providing apparatus can determine whether to trust a corresponding ID management apparatus without having a pre-agreement with an ID management apparatus regardless of which ID management apparatus is selected by a user in a user centric ID management circumstance.

Also, it is possible to precisely manage reliability since the reliability is evaluated according to types of the provided information, and to prevent damage caused by a harmful or incorrect ID management apparatus.

Also, it is possible to provide appropriate reliability management since a service providing apparatus, instead of a particular single subject, evaluates reliability of all ID management apparatuses by determining reliability according to a result of the performed evaluation.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An application providing apparatus for managing reliability of an identification (ID) management apparatus, the apparatus comprising:
an information using unit receiving ID information of a user from one of a plurality of ID management apparatuses that is selected by the user;
a voting unit verifying the ID information after providing a service to the user based on the ID information, voting whether to trust the ID information based on a result of the verification, and transmitting a result of the voting to a reliability management apparatus that computes the result of the voting; and
an evaluation unit receiving a reliability value calculated based on the result of the voting of the selected ID management apparatus from the reliability management apparatus, and determining whether to trust the selected ID management apparatus, if there is an inquiry whether to trust the selected ID management apparatus from the information using unit.

2. The application providing apparatus of claim 1, wherein the reliability of the ID management apparatus is determined according to types of information provided by the ID management apparatus.

3. The application providing apparatus of claim 1, wherein the evaluation unit determines whether to trust the selected ID management apparatus by finding out whether the reliability value is greater than the predetermined value.

4. The application providing apparatus of claim 1, wherein the reliability value is increased by the reliability management apparatus if the result of the voting is positive, and the reliability value is decreased if the result of the voting is negative.

5. A reliability management system comprising:
a plurality of ID management apparatuses selected according to a user's choice, and providing ID information of the user;
a plurality of application service providing apparatuses providing a service to the user based on the received ID information, verifying the ID information, and voting whether to trust the ID management apparatus based on a result of the verification; and
a reliability management apparatus computing a result of the voting made in the plurality of application service providing apparatuses, and calculating reliability value of the ID management apparatus.

6. The reliability management system of claim 5, wherein when determining whether to trust the ID management apparatus which provides the ID information, the application service providing apparatus determines whether to trust the ID management apparatus by receiving the reliability value of the ID management apparatus from the reliability management apparatus and comparing the reliability value with a predetermined value.

7. The reliability management system of claim 6, wherein the application service providing apparatus determines whether to trust the ID management apparatus according to types of information that is provided by the ID management apparatus.

8. The reliability management system of claim 5, wherein the reliability management apparatus grants reliability value to the ID management apparatus by computing the result of the voting according to each ID management apparatus and types of information that is provided by the ID management apparatus.

9. The reliability management system of claim 8, wherein the reliability management apparatus increases the reliability value if the result of the voting is positive, and decreases the reliability value if the result of the voting is negative.

10. A method of managing reliability of an ID management apparatus by an application service providing apparatus, the method comprising:
receiving ID information of a user from one of a plurality of the ID management apparatuses that is selected by the user;
providing a service to the user based on the ID information, and verifying the ID information;
voting whether to trust the ID information based on a result of the verification;
transmitting a result of the voting to a reliability management apparatus that computes the result of the voting; and
receiving a reliability value calculated based on the result of the voting of the selected ID management apparatus from the reliability management apparatus, and determining whether to trust the selected ID management apparatus, if there is an inquiry whether to trust the selected ID management apparatus.

11. The method of claim 10, wherein the reliability of the ID management apparatus is determined according to types of the information provided by the ID management apparatus.

12. The method of claim 10, wherein the determining of whether to trust the selected ID management apparatus comprises determining whether to trust the selected ID management apparatus by finding out whether the reliability value is greater than the predetermined value.

13. The method of claim 10, wherein the reliability value is increased by the reliability management apparatus if the result of the voting is positive, and the reliability value is decreased if the result of the voting is negative.

14. A method of managing reliability of an ID management apparatus, the method comprising:
providing ID information of a user by using one of a plurality of the ID management apparatuses according to the user's choice;
providing a service to the user by using an application service providing apparatus based on the received ID information, and verifying the ID information;
voting whether to trust the ID management apparatus which provides the ID information by using the application service providing apparatus based on a result of the verification; and
granting reliability value of the ID management apparatus by computing a result of the voting made in the plurality of application service providing apparatuses by using an reliability management apparatus.

15. The method of claim 14, further comprising: the application service providing apparatus determining whether to trust the ID management apparatus by receiving the reliability value of the ID management apparatus from the reliability management apparatus and comparing the reliability value with a predetermined value, when determining whether to trust the ID management apparatus which provides the ID information.

16. The method of claim 15, wherein the reliability of the ID management apparatus by the application service providing apparatus is determined according to types of the information provided by the ID management apparatus.

17. The method of claim 14, wherein the reliability management apparatus grants reliability value to the ID management apparatus by computing the result of the voting according to each ID management apparatus and types of information that is provided by the ID management apparatus.

18. The method of claim 17, wherein the reliability management apparatus increases the reliability value if the result of the voting is positive, and decreases reliability value if the result of the voting is negative.
